(19) United States
(12) Patent Application Publication
(10) Pub. No.: US 2008/0212143 A1
(43) Pub. Date: Sep. 4, 2008

(54) Image recording apparatus and method for restoring recording head for image recording apparatus

(76) Inventor: Takamasa Usui, Ogaki-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/980,057

(22) Filed: Oct. 30, 2007

(30) Foreign Application Priority Data
Oct. 30, 2006 (JP) 2006-294542

(51) Int. Cl. H04N 1/21

(52) U.S. Cl. 358/296

(57) ABSTRACT

An image recording apparatus includes a manuscript reader which reads a manuscript to generate image data; a recording head which has nozzles for discharging an ink and which discharges the ink from the nozzles to record an image on a recording medium based on the image data; a restoring mechanism which performs a restoring operation for restoring a discharge state of the nozzles; a controller which controls the manuscript reader and the restoring mechanism; and an instruction receiver which receives an instruction to generate the image data by reading the manuscript and record the image based on the image data. If the instruction receiver receives the instruction, the controller controls the manuscript reader to execute reading of the manuscript, and the controller controls the restoring mechanism based on a time at which the instruction is received to execute the restoring operation.

### CROSS REFERENCE TO RELATED APPLICATION

The present application claims priority from Japanese Patent Application No. 2006-294542, filed on Oct. 30, 2006, the disclosure of which is incorporated herein by reference in its entirety.

### BACKGROUND OF THE INVENTION

1. Field of the Invention

The present invention relates to an image recording apparatus including a recording head for discharging an ink from nozzles toward a recording medium, the image recording apparatus being provided with at least such a copy function that a manuscript is read and read image data is copied to a recording medium, and a method for restoring a recording head for the image recording apparatus as described above.

2. Description of the Related Art

A restoring mechanism, which brings about the satisfactory discharge state of nozzles, has been hitherto provided for some of copy machines (uni-function devices) for copying (outputting) the read image data to the recording medium by using a recording head of the ink-jet type to perform the recording by discharging the ink from the nozzles, and image recording apparatuses of the multi function type provided with, for example, the printer function, the copy function, the facsimile function, and the scan function in combination.

The restoring mechanism is operated such that the nozzle surface of the recording head is covered with a suction cap, and the interior of the suction cap is allowed to have the negative pressure by using a pump. Accordingly, the ink, which is contained in the recording head, is forcibly discharged to the outside to remove, for example, any viscous ink, any dried ink, and bubbles. Further, the ink contained in the nozzles is forcibly discharged from the nozzles to the outside by driving the recording head irrelevant to the recording operation so that the ink discharge state is maintained to be satisfactory. In general, the elapsed time is measured from the previous execution of the restoring operation. When the image recording operation is performed, if the elapsed time exceeds a predetermined elapsed time, then the restoring operation is performed automatically. Of course, if any discharge failure occurs, and the restoring operation is required, then the restoring operation can be also instructed by a user, for example, by operating the button irrelevant to the elapsed time.

However, in the case of the apparatus as described above, when the user intends to record the image on the recording medium, and the user instructs the image recording operation, if the predetermined time has already elapsed after performing the previous restoring operation, then the restoring operation is firstly executed before performing the recording operation. Therefore, the waiting time is increased until the completion of the image recording operation, and the user feels the inconvenience in many cases.

In view of the above, for example, an image forming apparatus (copy machine or multi function device having the copy function), in which a manuscript is read and the read image data is recorded on a recording medium, is described in Japanese Patent Application Laid-open No. 2005-238710 (see FIGS. 4 and 6). In this case, the operation, which is performed by a user prior to the reading of the manuscript, is judged as the operation before the instruction of the image recording operation (copy), and the restoring operation is performed, if necessary, before starting the recording operation.

In particular, the restoring operation is performed by detecting (judging) the fact that the cover of the manuscript stand for placing the manuscript thereon is opened, the size of the recording medium is set, the number of sheets of the recording media to be subjected to the recording is set, and/or the manuscript is set in an automatic document feeder (ADF). Accordingly, it is intended to shorten the period of time required until the completion of the image recording operation after the reading of the manuscript, as compared with the case in which the restoring operation is executed after the image recording operation is instructed (copy button is depressed).

In recent years, as described above, the multi function device or apparatus, which is provided with not only the copy function but also various functions including, for example, the facsimile function and the scan function in combination in a composite manner, is gradually versatily used. In the case of the multi function device as described above, it is overhasty to judge that the operation, which is ready for the copy, is performed, on the basis of the operation by the user prior to the start of the manuscript reading operation, for example, the detection of the fact that the opening/closing operation is performed for the cover of the manuscript stand and/or the detection signal of the manuscript-detecting switch provided for the automatic document feeder as described in Japanese Patent Application Laid-open No. 2005-238710, for the following reason. That is, the manuscript reading operation is also the essential operation in the facsimile function to be used during the transmission of the manuscript and in the scan function to be used to import the manuscript data into the personal computer. Therefore, it is impossible to draw a conclusion that the user performs the copy based on only the opening/closing operation of the manuscript cover and/or the placement of the manuscript on the document feeder.

### SUMMARY OF THE INVENTION

An object of the present invention is to solve the problem involved in the conventional technique as described above so that any useless start of the restoring operation for the nozzles is avoided, and the restoring operation is quickly started when the copy (duplication) is instructed to shorten the waiting time for the user until the completion of the copy (duplication).

According to a first aspect of the present invention, there is provided an image recording apparatus which records an image on a recording medium; the image recording apparatus including a manuscript reader which reads a manuscript to generate image data of the image; a recording head which has nozzles discharging an ink and which discharges the ink from the nozzles to record the image on the recording medium based on the image data; a restoring mechanism which performs a restoring operation for restoring a discharge state of the nozzles: a controller which controls the manuscript reader and the restoring mechanism; and an instruction receiver which receives an instruction to generate the image data by reading the manuscript and to record the image base on the image data, wherein when the instruction receiver receives the instruction, the controller controls the manuscript reader to execute reading of the manuscript, and the controller controls the restoring mechanism to execute the restoring operation based on a time at which the instruction is received.

According to the first aspect of the present invention, when the instruction receiver receives the instruction to read the manuscript and record the read image, the restoring operation is executed based on the time at which the instruction is received, together with the reading of the manuscript. Therefore, it is possible to shorten the time period required until the completion of the recording, as compared with a case in which the restoring operation is executed before the recording operation after the manuscript reading operation. Further, when the instruction to read the manuscript, which is accompanied by the recording operation, is made, the restoring operation for the recording head is executed. Therefore, any useless restoring operation is not executed by the instruction which is not accompanied by the recording operation, and any unnecessary ink is not consumed.

The image recording apparatus of the present invention may further include a manuscript detector which detects presence of the manuscript on the manuscript reader, wherein if the presence of the manuscript is detected by the manuscript detector and the instruction receiver receives the instruction, the controller may control the manuscript reader to execute the reading of the manuscript, and the controller may control the restoring mechanism based on the time at which the instruction is received to execute the restoring operation. In this case, the restoring process is not performed even when the manuscript is merely detected. When the manuscript reading instruction accompanied by the recording operation is further made, the restoring operation is executed for the recording head. In other words, the restoring operation is not executed in an uncertain state in which whether or not the recording operation is performed is indistinct. Therefore, any unnecessary ink is not consumed.

The image recording apparatus of the present invention may further include a timer which measures an elapsed time elapsed from the execution of the restoring operation to receiving of the instruction by the instruction receiver, wherein if the elapsed time measured by the timer exceeds a predetermined time, the controller may control the restoring mechanism to execute the restoring operation.

In the image recording apparatus of the present invention, the restoring mechanism may adjust the restoring operation depending on a length of the elapsed time measured by the timer. In this case, when the elapsed time is short, any unnecessary ink is not consumed by the restoring operation. On the other hand, when the elapsed time is long, it is possible to sufficiently restore the recording head.

In the image recording apparatus of the present invention, the restoring mechanism may include a pump which sucks the ink from the nozzles of the recording head, and a cap which covers the nozzles.

In the image recording apparatus of the present invention, the restoring operation may be adjusted by a number of times of suction of the ink from the nozzles of the recording head.

In the image recording apparatus of the present invention, the restoring operation may be adjusted by a length of time of suction of the ink from the nozzles of the recording head.

In the image recording apparatus of the present invention, the restoring operation may include a suction restoring operation which is performed for the recording head, and an operation in which the recording head is driven irrelevant to a recording operation to discharge the ink from the nozzles.

In the image recording apparatus of the present invention, the restoring mechanism may further include a wiper which wipes a nozzle surface formed on the recording head.

In the image recording apparatus of the present invention, the instruction receiver may be a key for receiving the instruction from a user.

According to a second aspect of the present invention, there is provided a method for restoring a recording head for an image recording apparatus; the method including executing a restoring operation for the recording head; measuring an elapsed time elapsed after the execution of the restoring operation; receiving an instruction to generate image data of the image by reading a manuscript and to record an image based on the image data; and performing, upon receiving the instruction, comparison between the elapsed time and a predetermined time and executing the restoring operation for the recording head based on a result of the comparison.

According to the second aspect of the present invention, if the instruction to read the manuscript and record the read image is received, then the predetermined time is compared with the elapsed time after the execution of the restoring operation, and the restoring operation is executed based on the result of the comparison. Therefore, the time period, which is required until the completion of the recording, can be shortened as compared with a case in which the restoring operation is executed before the recording operation after the operation for reading the manuscript. When the instruction to read the manuscript accompanied by the recording operation is received, the restoring operation is executed for the recording head. Therefore, any useless restoring process is not executed by the instruction which is not accompanied by the recording operation, and any unnecessary ink is not consumed.

In the method for restoring the recording head for the image recording apparatus of the present invention, the reading of the manuscript and the restoring operation for the recording head are concurrently performed when the instruction is received. In this case, the time period, which is required until the completion of the recording, can be shortened as compared with a case in which the restoring operation is executed before the recording operation after the operation for reading the manuscript.

In the method for restoring the recording head for the image recording apparatus of the present invention, the restoring operation may be adjusted depending on a length of the elapsed time.

In the method for restoring the recording head for the image recording apparatus of the present invention, the restoring operation may include suction of an ink from nozzles which are formed for the recording head and which discharge the ink.

In the method for restoring the recording head for the image recording apparatus of the present invention, the restoring operation may be adjusted by a number of times of the suction of the ink from the nozzles.

In the method for restoring the recording head for the image recording apparatus of the present invention, the restoring operation may be adjusted by a length of time of the suction of the ink from the nozzles.

### BRIEF DESCRIPTION OF THE DRAWINGS

FIG. 1 shows a perspective view illustrating a multi function device to which the present invention is applied.

FIG. 2 shows a side sectional view illustrating the multi function device.

FIG. 3 shows a schematic plan view illustrating an arrangement of a recording section.

FIG. 4 shows a perspective view illustrating the recording section in a state in which a carriage is removed.

FIG. 5 shows a block diagram illustrating a control system.

FIG. 6 illustrates a table stored in ROM.

FIG. 7 shows a flow chart illustrating a main routine of the operation to be performed by the multi function device.

FIG. 8 shows a flow chart illustrating a subroutine of the restoring process.

### DESCRIPTION OF THE PREFERRED EMBODIMENTS

An explanation will be made below about a most preferred embodiment in which the present invention is embodied. In this embodiment, the present invention is applied to a multi function device 1 (MFD: Multi Function Device) provided with the printer function, the copy function, the scan function, and the facsimile function as one embodiment of the image recording apparatus.

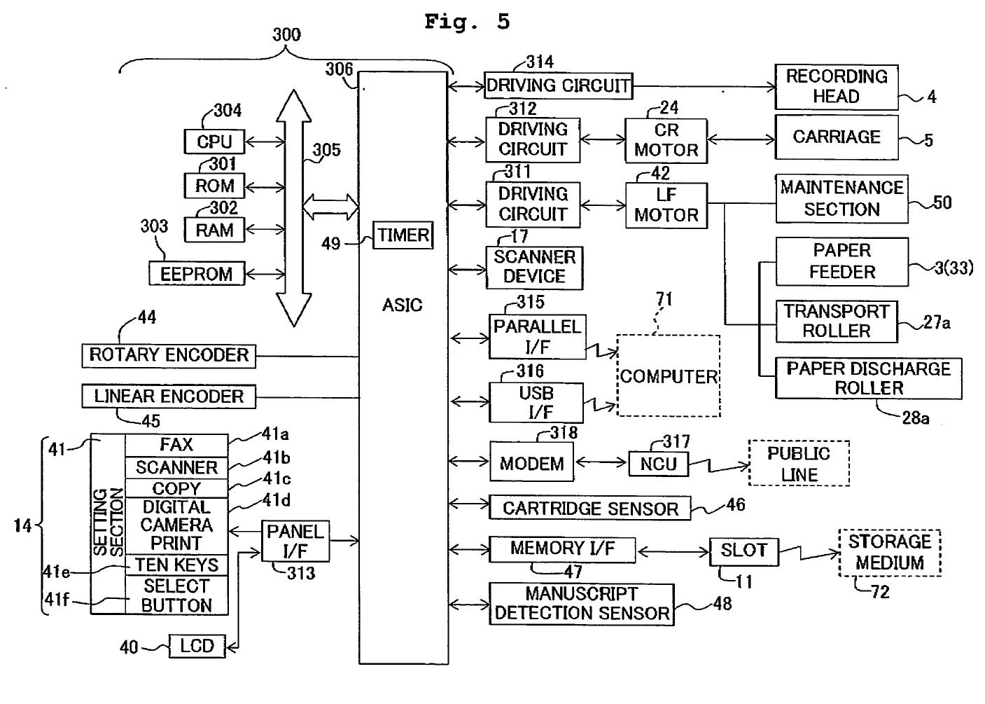

The multi function device 1 is connectable to a computer 71 such as a personal computer and the telephone communication network (public line), to which a storage medium (removable memory) 72 is detachably connected (see FIG. 5). The multi function device 1 is capable of recording the image (photograph and document) on the printing paper as an example of the recording medium, based on the image data (including, for example, the photograph data and the document data) received, fox example, from the computer, any other facsimile apparatus, and the storage medium 72 to be installed.

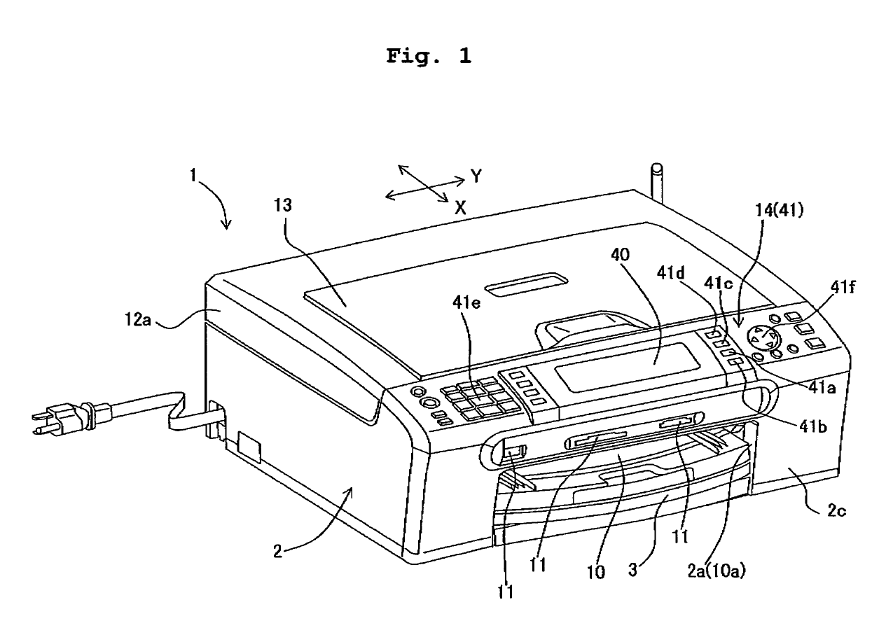

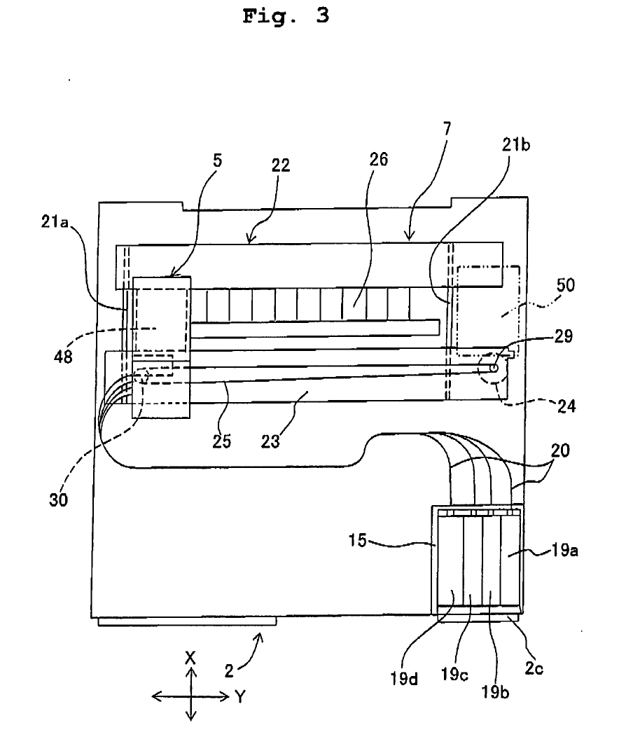

In this embodiment, as shown in FIG. 3, a recording section 7 is provided in a main body case (housing) 2 as the main apparatus body. As shown in FIG. 1, a paper feed cassette device 3, which is insertable/extractable (capable of being put in and out substantially in the horizontal direction) from an insert port 2a that is open at the front side of the main body case 2, is arranged in an accommodating space disposed at a bottom portion of the main body case 2. In the following description, the side, on which the insert port 2a of the main body case 2 is present, is referred to as “front”, and the other sides are referred to as “back (backward)”, “left”, and “right” of the device or apparatus based on the “front”.

Slots 11 are provided at the front surface portion of the main body case 2. Various types of storage media 72 (see FIG. 5), in which, for example, the image data and the control data for controlling the image recording are stored, can be installed to the slots 11. The image data, which is recorded in the storage medium 72, can be recorded on the printing paper as well.

Various card-shaped media, each of which is composed of, for example, a semiconductor memory, are commercially available as the storage medium 72 capable of being installed. The slots 11, which have three different sizes as shown in FIG. 1, can be adapted to the media having various sizes. Whether or not the storage medium 72 is installed to the slot 11 can be detected by a controller 300 including, for example, CPU shown in FIG. 5 as described later on.

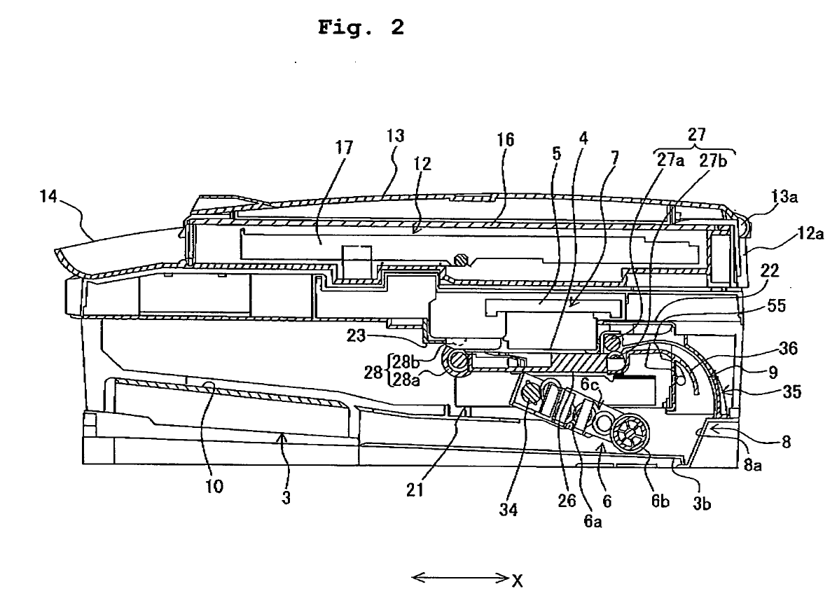

As shown in FIG. 2, a scanner (image reading device) 12, which is provided, for example, in order to read the manuscript in the copy function, the facsimile function, and the scan function, is arranged in a scanner case 12a at an upper portion of the main body case 2. An operating section 14 (described later on), which is provided to perform various operations and display, is provided in front of the scanner 12 on the upper side of the main body case 2. The operating section 14 includes a setting section 41 for allowing a user to make various types of setting for the multi function device 1, and a display 40 for displaying various types of information for the user. The recording section 7, a paper discharge tray 10, and other components are arranged in the projection area of the scanner 12 and the operating section 14 as viewed in a plan view.

An accommodating section 15, which accommodates ink cartridges 19 (for four colors of yellow, magenta, cyan, and black in this embodiment, as individually affixed with 19a to 19d), is contained at a portion disposed on the right side of the insert port 2a (right sides as shown in FIGS. 1 and 3) on the front side of the main body case 2. The inks contained in the respective ink cartridges 19a to 19d are supplied to the recording head 4 independently respectively via flexible ink supply tubes (tubes) 20.

When a door 2c, which is provided openably/closably on the right side of the insert port 2a, is opened downwardly, the respective ink cartridges 19a to 19d, which are contained in the accommodating section 15, can be taken out and exchanged.

The scanner 12, which is provided as an example of the manuscript reading device (manuscript reader) of the present invention, includes a glass plate 16 on which the manuscript can be placed, and an image scanner device 17 which is provided on the lower side thereof to read the manuscript. The image scanner device 17 is provided so that it is capable of making the reciprocating movement in the direction (Y direction) perpendicular to the plane of the paper as viewed in FIG. 2. A manuscript cover member 13, which covers the glass plate 16, is attached openably/closably with respect to an image reading section case 12a by the aid of a hinge 13a disposed at the backward end thereof (on the right side as viewed in FIG. 2).

Another example of the manuscript reading device is available, which is provided with an automatic document feeder disposed on the manuscript cover member 13, the automatic document feeder including a manuscript tray which is capable of placing a plurality of manuscript sheets, and a transport mechanism which transports the manuscript in a U-turn form while separating the placed manuscript sheets one by one (not shown). In this manuscript reading device, the manuscript, which is transported by the automatic document feeder, passes over the image scanner device 17 allowed to stand still at one end of the lower surface of the glass plate 16 so that the image data of the manuscript is read.

As shown in FIG. 2, the recording section 7 is constructed such that various functional parts are supported by a frame-shaped main frame 21 having its open upper surface. The main frame 21 is composed of a pair of left and right side plates 21a, 21b, and laterally long plate-shaped guide members 22, 23 which are supported by side portions thereof and which extend in the Y direction (scanning direction). A carriage 5 is slidably supported while spanning the both guide members 22, 23. A platen 26, which supports the printing paper, is arranged opposingly to the lower surface side of the recording head 4 carried by the carriage 5. The carriage 5 is connected to a timing belt 25 which is arranged by being wound around pulleys 29, disposed on the upper surface of the guide member 23. The carriage 5 makes the reciprocating movement by driving the pulley 29 by means of a CR (carriage) motor 24.

A resist roller pair 27, which has both of the transport function and the resist function, is arranged on the upstream side from the platen 26 in the transport direction. The resist roller pair 27 is composed of a driving roller 27a and a driven roller 27b, which transports the printing paper to the gap between the platen 26 and the nozzle forming surface of the lower surface of the recording head 4. A discharge roller pair 28 is arranged on the downstream side from the platen 26. The discharge roller pair 28 is composed of a spur 28b which makes contact with the upper surface of the printing paper, and a driving paper discharge roller 28a which makes contact with the lower surface of the printing paper to transport the printing paper having been subjected to the recording to the paper discharge tray 10.

An inclined plate 8, which has an elastic separating pad 8a for separating the printing paper, is arranged on the backward side (backward end side, right side as viewed in FIG. 2) of the paper feed cassette device 3. A paper feed roller 6b, which is provided at the lower end of a paper feed arm 6a on the side of the main body case 2, is rotated by the aid of a gear transmission mechanism 6c from the side of a drive shaft 34. Accordingly, the printing paper sheets, which are accumulated in the paper feed cassette device 3, are transported one by one.

The transported printing paper is fed to the resist roller pair 27 via a U-turn pass (paper feed transport passage) 9 which is directed laterally upwardly and which is constructed between an inner transport passage member 36 and an outer transport passage member 35 having a laterally U-shaped form as viewed in a side view. The printing paper, which is subjected to the recording in the recording section 7, is discharged onto the paper discharge tray 10 with its recording surface being directed upwardly. The paper discharge tray 10 is arranged on the upper side of the paper feed cassette device 3. A paper discharge port 10a (upper portion of the insert port 2a, see FIG. 1), which is communicated with the paper discharge tray 10, is open toward the front surface of the main body case 2.

A detecting lever 55, which transverses the paper feed transport passage 9 and which is rotatable, is provided on the downstream side of the paper feed transport passage (U-turn pass) 9 to detect the passage of the forward end edge and the backward end edge of the printing paper passed through the paper feed transport passage (U-turn pass) 9 (see FIG. 2).

An ink-receiving section 48 which is disposed on one end side (at a portion close to the left side plate 21a as shown in FIG. 3) and a maintenance unit 50 which is disposed on the other end side (at a portion close to the right side plate 21b as shown in FIG. 3) are arranged respectively as the restoring mechanism for the recording head 4 at the outside of the width of the printing paper to be transported.

The ink-receiving section 48 is provided corresponding to the flashing position of the carriage 5. The recording head 4 periodically performs the ink discharge (flashing) in order to avoid the clog-up of the nozzles at the flashing position during the recording operation. The ink is received by the ink-receiving section 48.

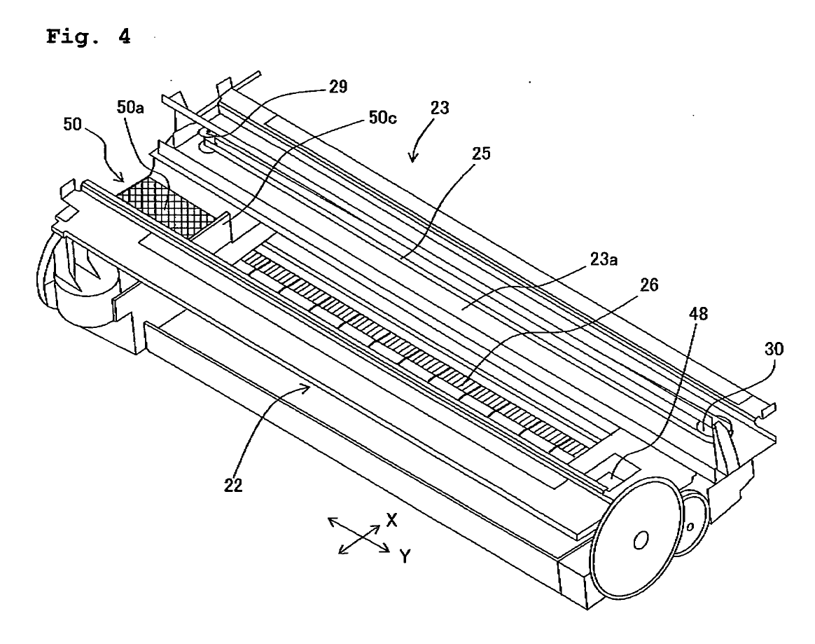

The maintenance unit 50 is provided corresponding to the waiting position (home position) of the carriage 5. The maintenance unit 50 performs the suction restoring operation (purging) for the recording head 4. The maintenance unit 50 is provided with a suction cap member 50a which is connected to the pump statically placed on the main body frame 2, and a wiper 50c which wipes the nozzle forming surface (see FIG. 4).

In the restoring operation, a plurality of operations are performed singly or in combination. At first, the nozzle forming surface of the recording head 4 is covered with the suction cap member 50a to suck the bubbles contained in the ink as well together with the dried or viscous ink from the nozzles of the recording head 4. When the suction cap member 50a is separated from the nozzle forming surface, and the carriage 5 is moved in the direction toward the image recording area from the portion of the maintenance unit 50, then the wiping is performed for the nozzle forming surface of the recording head 4 by the wiper 50c. In other words, the cleaning is performed for the nozzle surface of the recording head 4 by allowing the recording head 4 to make the relative movement with respect to the wiper 50c. On the other hand, one of the restoring operations is also performed such that the carriage 5 is moved to the flashing position, and the recording head 4 is driven irrelevant to the recording operation to discharge the ink from the nozzles toward the ink-receiving section 48.

The transport mechanism composed of the paper feed roller 6a, the driving roller 27a, and the paper discharge roller 28a, and the maintenance unit 50 use one LF (printing paper feed or leaf feed) motor 42 as the driving source, which are selectively driven in accordance with the switching of the direction of rotation.

On the other hand, the restoring operation, which is performed by the maintenance unit 50, can be adjusted (regulated) depending on the condition including, for example, the elapsed time from the previous execution of the restoring operation as described later on. In this embodiment, the operation, in which the recording head is covered with the suction cap member 50a, the suction is effected by the suction pump, and the cap is separated, is defined as a series of the restoring operation. The restoring operation can be adjusted by changing the number of times of repetition of the series of the restoring operation, in other words, the number of times of suction with the suction pump. Alternatively, the restoring operation can be also adjusted by controlling the length of the suction time of the suction pump.

Next, the operating section 14 will be explained. The operating section 14 is provided to have approximately the same width as the lateral width of the multi function device 1 on the upper front side of the main body case 2. The operating section 14 is arranged in an inclined form in which the front portion descends as a whole so that the operating section 14 is easily usable by the user. A display 40 of a liquid crystal screen is arranged at a central portion of the operating section 14. The backward end portion of the display 40 is capable of making the rotary movement in the vertical direction by the aid of a hinge provided at the front end side thereof. The angle of the display 40 can be adjusted so that the user can view the display 40 with ease.

For example, a plurality of instruction buttons (keys) 41a, 41b, 41c, 41d and ten keys Ale, which serve as the setting section 41 for the user to select and set, for example, the various functions (operations) provided for the multi function device 1, are arranged on the both sides to interpose the display 40 of the operating section 14. Those arranged as the buttons include function keys (mode setting keys) 41a, 41b, 41c, 41d explicitly indicated as “Fax (FAX)”, “Scan”, “Copy”, and “Digital Camera Print”. Any one of the facsimile function, the scan function, the copy function, and the function to print the image data stored in the installed storage medium can be selected and executed by the user by selectively depressing the function keys. Other than the above, a button to instruct the restoring operation for the recording head is also prepared. An image scroll button 41f and a select button are also included in the buttons provided in the setting section 41. The operation can be also instructed by selecting and/or setting the item displayed on the display 40.

Next, the controller 300 of the image recording apparatus (multi function device) 1 will be explained with reference to FIG. 5 (block diagram). The controller 300 executes the control of the overall operation and the restoring operation of the image recording apparatus 1. In particular, the present invention relates to the control method for controlling the restoring operation when the copy function is executed.

The controller 300 principally includes a microcomputer which is composed of CPU 304, ROM 301, RAM 302, and EEPROM 303, and ASIC (Application Specific Integrated Circuit) 306 which is connected thereto via a bus 305.

For example, programs, which control the various operations of the ink-jet printer function, the facsimile function, the scan function, and the copy function, are stored in ROM 301. RAM 302 is used as a working area and a storage area in which various data are temporarily stored to be used when CPU executes the programs.

NCU (Network Control Unit) 317 is connected to ASIC 306. The communication signal, which is inputted via NCU 317 from the communication line network such as the public line, is demodulated by a modem 318, and then the signal is inputted into ASIC 306. When ASIC 306 transmits the image data to the outside by, for example, the facsimile communication, then the image data is modulated into the communication signal by the modem 318, and the communication signal is outputted via NCU 317 to the communication line network.

ASIC 306 generates, for example, the phase excitation signals to apply the electricity to the respective motors in accordance with the instruction from the microcomputer, and the signals are given to the motor driving circuits 311, 312. The driving signals are applied to the LF motor 42 and the CR motor 24 to control the LF motor 42 and the CR motor 24.

Further, those connected to ASIC 306 include, for example, the scanner device 17 for reading the image of the manuscript, a panel interface 313 for the operating section 14, a parallel interface 315 and a USB interface 316 for sending and receiving the data via the parallel cable and the USB cable with respect to the external equipment such as the personal computer, and a memory interface 319 for the slot 11.

The driving circuit 314 is provided in order that the ink is selectively discharged at the predetermined timing from the recording head 4 toward the printing paper. The driving circuit 314 receives the signal generated and outputted by the ASIC 306 on the basis of the program of the microcomputer to drive and control the recording head 4.

Further, those connected to ASIC 306 include, for example, a rotary encoder 44 for detecting the amount of rotation of the resist roller 27, and a linear encoder 45 for detecting the amount of movement and the position of movement of the carriage 5. Although not shown, those also connected to ASIC 306 include, for example, a cartridge sensor 46 for detecting the fact that the ink cartridge 19 is exchanged, and a printing paper sensor (not shown) provided in relation to the detecting lever 55 positioned on the downstream side in the transport direction of the transport passage 9.

A manuscript-detecting sensor 48 (manuscript detector), which detects whether or not the manuscript is present on the glass plate 16 of the scanner 12, is connected to ASIC 306. In ordinary cases, the manuscript-detecting sensor 48 is composed of light-reflective type sensors arranged upwardly in the detecting direction at appropriate intervals in the manuscript placement area on the lower surface side of the glass plate 16. The image scanner device 17, which is included in the scanner 12, can be also used as the manuscript-detecting sensor. In the case of the image reading apparatus provided with the automatic document feeder, the manuscript-detecting sensor detects the presence of absence of the manuscript disposed on the manuscript tray.

A timer 49 is contained in ASIC 306 or the microcomputer. The timer 49 measures the elapsed time (elapsed days) from the restoring operation previously executed for the recording head 4 as described later on.

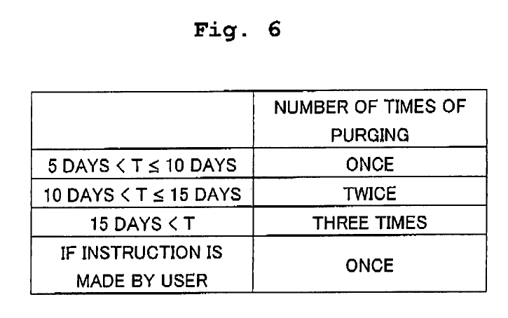

Next, an explanation will be made about the contents of the restoring operation stored in ROM 301. A table shown in FIG. 6 is stored in ROM 301. The specified numerical values shown in the table are provided by way of example, which may be appropriately changed depending on, for example, the arrangement of the recording head 4 and the maintenance unit 50 and the ability of the suction pump 50b.

“T” represents the elapsed time (count value) measured by the timer 74 from the previous execution of the restoring operation. The “number of times of purging” shown in the table indicates the number of times of repetition of the series of the restoring operation in which the nozzle forming surface of the recording head 4 is covered with the suction cap member 50b to effect the suction with the suction pump 50c.

In this embodiment, the setting is made as follows. That is, the number of times of purging is set to once if the time (number of days) T from the previous execution of the restoring operation is above 5 days and not more than 10 days. The number of times of purging is set to twice if the time T is above 10 days and not more than 15 days. The number of times of purging is set to three times if the time T is above 15 days. Further, the number of times of purging is set to once in the case of the restoring process (referred to as “designated restoring process”) to be performed by being designated by the user. It is also allowable that the flashing, in which the ink is discharged from the recording head irrelevant to the recording operation, is performed in place of or continuously to the restoring operation in which the suction is effected with the pump.

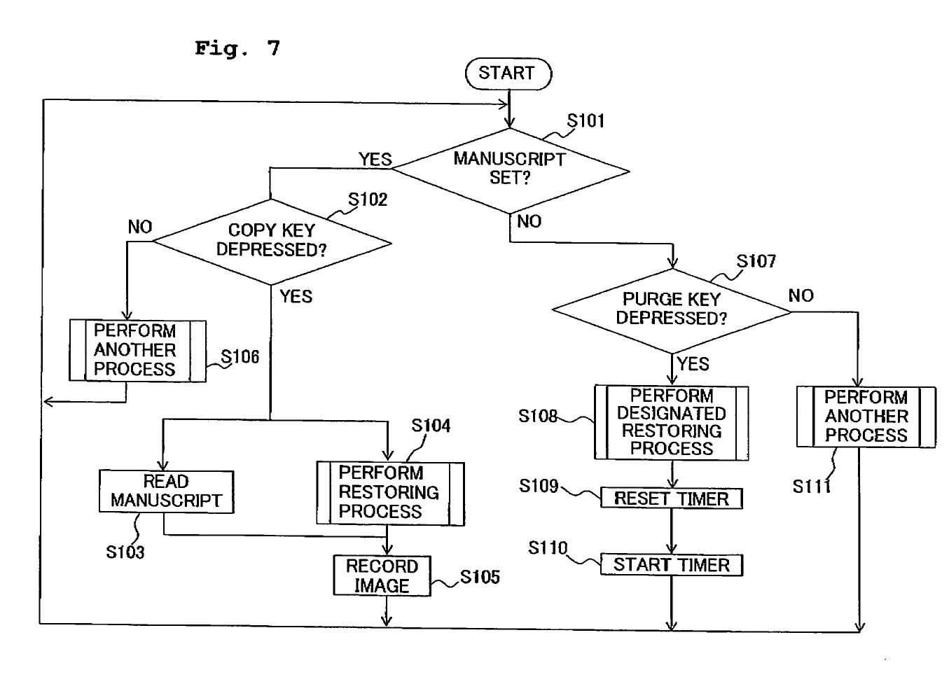

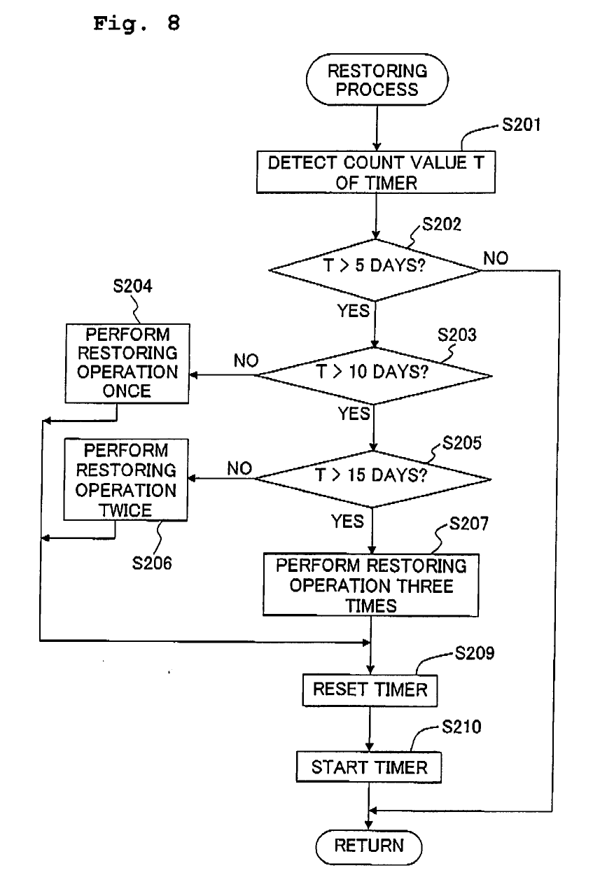

Next, an explanation will be made with reference to flow charts shown in FIGS. 7 and 8 about the control in relation to the restoring operation for the recording head 4 of the multi function device 1.

In this embodiment, the controller 300 controls the restoring mechanism (including the program for allowing the maintenance unit 50 and the recording head 4 to perform the flashing) to execute the restoring operation at a predetermined timing. The setting section 41 has the copy key (instruction receiver) 41c which receives the instruction of the copy (duplication) from the user. In other words, when the copy key 41c receives the copy instruction from the user, then the controller 300 controls the scanner 12 to execute the reading of the manuscript and the generation of the image data, and the controller 300 controls the recording head 4 to execute the recording of the image on the basis of the image data continuously thereto. Concurrently therewith, the controller controls the restoring mechanism to execute the restoring operation based on the time at which the instruction from the user is received.

That is, when the user intends to copy the manuscript, and the copy key 41c is depressed, then the restoring operation is performed for the recording head 4 concurrently with the reading operation for the manuscript. Accordingly, the time period, which is required until the completion of the recording on the printing paper, can be shortened.

With reference to the flow chart (main routine) shown in FIG. 7, if it is detected that the manuscript is present (set) on the manuscript reading device (S101: yes), and the user depresses the copy key 41c, then the copy is instructed thereby (S102: yes). Accordingly, the manuscript reading operation (S103), which is to be performed by the scanner 12, is started, while the subroutine (S104) of the restoring process, which includes the restoring operation to be performed by the restoring mechanism, is started. Specifically, when the copy is executed by placing the manuscript one by one on the glass plate 16, the manuscript is detected by the manuscript-detecting sensor 48. In the case of the manuscript reading device provided with the automatic document feeder, when the manuscript is set in the manuscript tray (not shown), the manuscript is detected by the manuscript-detecting sensor which is arranged for the manuscript tray. When the user depresses the copy key 41c, the manuscript reading (S103) and the subroutine of the restoring operation (S104) are started.

In this situation, the microcomputer alternately drives the image scanner device 17 and the maintenance unit 50 for every minute time period based on the program to make the control so that the both are operated substantially concurrently. Alternatively, it is also allowable that hardware circuits, which execute the respective series of operations of the image scanner device 17 and the maintenance unit 50, are provided for ASIC 306. In this case, when the microcomputer issues the instruction to start the operations to the respective hardware circuits, the respective hardware circuits concurrently drive the image scanner device 17 and the maintenance unit 50 respectively.

The image recording (S105) for recording the read image data on the printing paper is started at the point of time at which any one of the manuscript reading (S103) and the restoring operation (S104) is completed later. As a result, it is possible to substantially shorten the period of time required until the completion of the copy as compared with any series type process in which any one of the manuscript reading operation and the restoring process is executed earlier and then the other is executed as in the conventional technique.

Owing to the two processes carried out in the concurrent manner as described above, the effect, in which the time period from the start to the end of the copy is shortened, is remarkably exhibited when the number of sheets of the manuscript to be read is large.

Next, the subroutine of the restoring process in the controller 300 will be explained with reference to FIG. 8. At first, the elapsed time period (count value) T, which is measured by the timer 49 from the previous execution of the restoring operation, is detected (S201). It is judged whether or not the count value T is above 5 days (S202). If the count value is not above 5 days (S202: no), then it is judged that the execution of the restoring operation is unnecessary, and the subroutine of the restoring process is completed to return to the main routine.

If the count value T is above 5 days and not more than 10 days (S202: yes and S203: no), then the “number of times of purging: once” is read from the table shown in FIG. 6, and the series of restoring operation is executed once (S204) by controlling the restoring mechanism. If the count value T is above 10 days and not more than 15 days (S203: yes and S205: no), then the “number of times of purging: twice” is read from the table, and the series of restoring operation is executed twice (S206) by controlling the restoring mechanism. If the count value T is above 15 days (S206: no), then the “number of times of purging: three times” is read from the table, and the series of restoring operation is executed three times (S207) by controlling the restoring mechanism.

If the restoring operation is completed (S204, S206, S207), then the count value T of the timer 49 is reset (S209), and the count of the timer 49 is started again (S210) to return to the main routine.

If a state is given (S102: no) in the flow chart shown in FIG. 7, in which the user does not turn ON the copy key 41c although the manuscript is set (S101: yes), for example, then there is also a possibility that the user intends to transmit the manuscript by facsimile, and there is also a possibility that the user intends to scan the manuscript in order to send the image data to any external computer or the like. In other words, the recording operation is not necessarily performed. Therefore, the restoring process is not performed, and any other process is executed (S106). That is, the routine waits for the instruction from the user to execute the operation including, for example, the facsimile transmission and the scanning instructed by the user.

If the manuscript is not set (S101: no) in the flow chart shown in FIG. 7, and the user instructs the restoring process (S107: yes), for example, by the purge key, then the designated restoring process is performed only once as described above (S108). After that, the timer 49 is reset (count number is made zero) (S109). Subsequently, the count by the timer 49 is immediately started (S110), and then the routine is returned to the position before S101. If the restoring process instruction is not made by the user (S107: no), the routine performs any other process (S111). That is, the routine waits for the instruction from the user to execute the operation instructed by the user. The routine is returned to the position before S101.

As described above, in this embodiment, it is detected that the manuscript is present by the manuscript-detecting sensor. Further, when the reading of the manuscript and the recording of the read image are instructed by the user, if it is judged that the restoring operation by the restoring mechanism is unnecessary, then the recording operation is started after performing the manuscript reading operation. On the other hand, if it is judged that the restoring operation by the restoring mechanism is necessary, the control is made so that the manuscript reading operation and the restoring operation for the recording head are executed or started simultaneously in the concurrent manner. Therefore, it is possible to shorten the time period required until the completion of the recording as compared with a case in which the restoring operation is executed before the recording operation after the manuscript reading operation. It is possible to dissolve the inconvenience of the user. Further, the restoring process for the recording head is performed only when the manuscript reading operation accompanied by the recording operation is instructed except when the user instructs the restoring process. Therefore, the restoring process is not executed by any instruction not accompanied by the recording operation. Therefore, any useless restoring process is not executed by the instruction not accompanied by the recording operation, and any unnecessary ink is not consumed.

The restoring operation can be adjusted depending on the length of the elapsed time from the previous restoring operation. Therefore, the ink is not unnecessarily consumed in the restoring operation, and the state of the recording head can be satisfactorily restored in the reliable manner.

It is also allowable to provide such an arrangement that whether or not the control shown in FIG. 7 is performed can be set by the user.

This embodiment is illustrative of the case in which the copy key 41c, which receives the instruction of the copy (duplication) from the user, is the instruction receiver. However, the instruction receiver is not limited thereto. For example, ASIC 306, which receives the copy instruction from the application on the computer 71 connected to the image recording apparatus, may also function as the instruction receiver. In this case, the effect, which is the same as or equivalent to that of the embodiment of the present invention, can be also obtained.

This embodiment is illustrative of the case in which the present invention is applied to the image recording apparatus based on the ink-jet system in which the recording head 4 carried on the carriage 5 makes the reciprocating movement along the guide members 22, 23 together with the carriage 5. However, the operation flow shown in FIGS. 7 and 8 can be also applied to another image recording apparatus having a line type head in which a plurality of nozzles are aligned in series in the scanning direction.

This embodiment is illustrative of the case in which the image recording apparatus of the present invention is applied to the image recording apparatus based on the ink-jet system in which the recording is performed by discharging the ink from the nozzles. However, the present invention is not limited thereto, which may be improved and modified within a range of the appended claims. For example, the liquid is not limited to the ink, and the present invention is also applicable to any image recording apparatus to be used in a variety of fields including, for example, the medical and the analysis, provided that the apparatus is an image recording apparatus which is provided with a reading device, which records the image by discharging the liquid based on the read image, and which requires the discharge of the viscous liquid contained in the head and/or the air contained in the liquid flow passage.

What is claimed is:

1. An image recording apparatus which records an image on a recording medium, the image recording apparatus comprising:
a manuscript reader which reads a manuscript to generate image data of the image;
a recording head which has nozzles discharging an ink and which discharges the ink from the nozzles to record the image on the recording medium based on the image data;
a restoring mechanism which performs a restoring operation for restoring a discharge state of the nozzles;
a controller which controls the manuscript reader and the restoring mechanism; and
an instruction receiver which receives an instruction to generate the image data by reading the manuscript and to record the image based on the image data,
wherein when the instruction receiver receives the instruction, the controller controls the manuscript reader to execute reading of the manuscript, and the controller controls the restoring mechanism to execute the restoring operation based on a time at which the instruction is received.

2. The image recording apparatus according to claim 1, further comprising a manuscript detector which detects presence of the manuscript on the manuscript reader, wherein if the presence of the manuscript is detected by the manuscript detector and the instruction receiver receives the instruction, the controller controls the manuscript reader to execute the reading of the manuscript, and the controller controls the restoring mechanism based on the time at which the instruction is received to execute the restoring operation.

3. The image recording apparatus according to claim 1, further comprising a timer which measures an elapsed time elapsed from the execution of the restoring operation to receiving of the instruction by the instruction receiver, wherein if the elapsed time measured by the timer exceeds a predetermined time, the controller controls the restoring mechanism to execute the restoring operation.

4. The image recording apparatus according to claim 1, wherein the restoring mechanism adjusts the restoring operation depending on a length of the elapsed time measured by the timer.

5. The image recording apparatus according to claim 1, wherein the restoring mechanism includes a pump which sucks the ink from the nozzles of the recording head, and a cap which covers the nozzles.

6. The image recording apparatus according to claim 5, wherein the restoring operation is adjusted by a number of times of suction of the ink from the nozzles of the recording head.

7. The image recording apparatus according to claim 5, wherein the restoring operation is adjusted by a length of time of suction of the ink from the nozzles of the recording head.

8. The image recording apparatus according to claim 4, wherein the restoring operation includes a suction restoring operation which is performed for the recording head, and an operation in which the recording head is driven irrelevant to a recording operation to discharge the ink from the nozzles.

9. The image recording apparatus according to claim 5, wherein the restoring mechanism further includes a wiper which wipes a nozzle surface formed on the recording head.

10. The image recording apparatus according to claim 1, wherein the instruction receiver is a key for receiving the instruction from a user.

11. A method for restoring a recording head for an image recording apparatus, the method comprising:
executing a restoring operation for the recording head;
measuring an elapsed time elapsed after the execution of the restoring operation;
receiving an instruction to generate image data of the image by reading a manuscript and to record an image based on the image data; and
performing, upon receiving the instruction, comparison between the elapsed time and a predetermined time and executing the restoring operation for the recording head based on a result of the comparison.

12. The method for restoring the recording head for the image recording apparatus according to claim 11, wherein the reading of the manuscript and the restoring operation for the recording head are concurrently performed when the instruction is received.

13. The method for restoring the recording head for the image recording apparatus according to claim 11, wherein the restoring operation is adjusted depending on a length of the elapsed time.

14. The method for restoring the recording head for the image recording apparatus according to claim 13, wherein the restoring operation includes suction of an ink from nozzles which are formed for the recording head and which discharge the ink.

15. The method for restoring the recording head for the image recording apparatus according to claim 14, wherein the restoring operation is adjusted by a number of times of the suction of the ink from the nozzles.

16. The method for restoring the recording head for the image recording apparatus according to claim 14, wherein the restoring operation is adjusted by a length of time of the suction of the ink from the nozzles.
